(19) United States
(12) Patent Application Publication
(10) Pub. No.: US 2012/0303642 A1
(43) Pub. Date: Nov. 29, 2012

(54) AUTOMATED FILE-CONVERSION SYSTEM AND PROCESS FOR A MEDIA-GENERATION SYSTEM

(75) Inventor: David Coy Laughlin, JR., Akron, OH (US)

(73) Assignee: GBS Corp.

(21) Appl. No.: 13/113,353

(22) Filed: May 23, 2011

(51) Int. Cl. G06F 17/30

(52) U.S. Cl. 707/756; 707/E17.006

(57) ABSTRACT

An automated file-conversion system and process for a media-generation system includes a computer system configured to receive at least one contact data file. Upon receipt of the contact data file, the computer system automatically determines the file type by identifying the hexadecimal identifier embedded within the contact data file. Once the file type of the contact data file is identified, the computer system automatically selects a compatible software module that is able to access the file so that the data can be placed in a standardized format and segmented. After the data has been segmented, the computer system saves the contact data file in a standardized file type that is compatible for processing by a media-generation system.

### TECHNICAL FIELD

The present invention generally relates to file-conversion systems for media-generation systems. Particularly, the present invention relates to a system and process for automatically identifying and converting a data file of one or more file types to a standardized file type that is compatible for use with media-generation software tools. More particularly, the present invention relates to a system and process for automatically formatting data of one or more data records into a predetermined format.

### BACKGROUND OF THE INVENTION

Current media-generation systems generate media communications, such as direct mailings, emails, uniform resource locator (URL), and microsites to communicate marketing messages or other media communications to targeted recipients. Such media-generation systems utilize data files or databases of contact data records that identify the name, address, and various other demographic and personal data of each of the target recipients to which marketing messages are to be sent. The data records contained in the data files or databases is collected from a variety of data acquisition sources, such as point-of-sale terminals, websites, customer databases, telephone or in-person solicitation, and the like. However, because the data records contained in the data files and databases are generated from a wide variety of sources, the contact data in each collected data record is generally formatted in an inconsistent manner and stored in data files or databases of various formats.

Thus, current media-generation systems and software, such as XMPIE, PAGE FLEX, JET LETTER, GMC PRINTNET, and the like that are used to generate the marketing or media communications from the raw data records require that the data files or databases be placed in a standardized file format in order to be processed.

Thus, before the data records can be formatted whereby the data is organized into a predetermined format, the file type of the data file or database must first be identified, then the appropriate software tool or utility that is configured to edit the data file or database must be manually selected by the operator so that the data records contained therein can be accessed and modified. That is, currently in order to access the data so that it is suitable for processing by a media-generation system, such as XMPIE, an operator must manually identify the file type of the data file and then determine which editing software tool to use to manually organize or format the data so that it can be correctly interpreted by the media-generation system. Moreover, because such data files or databases generally include a substantial number of data records, an operator must expend a substantial amount of time processing the data records, which dramatically delays the rate at which marketing messages can be distributed to the target recipient, which is undesirable.

Therefore, there is a need for an automated file-conversion system and process that is capable of automatically identifying the file type of a data file and selecting the appropriate software component to automatically edit the data stored therein, so as to be placed in a predetermined standardized format. In addition, there is a need for an automated file-conversion system and process that automatically converts and stores formatted data files in a predetermined file type. There is also a need for an automated file-conversion system and process that automatically segments contact data in accordance with predefined criteria.

### SUMMARY OF THE INVENTION

In light of the foregoing, it is a first aspect of the present invention to provide an automated file-conversion system comprising a computer system adapted to receive at least one data file having a file type, the at least one data file having contact data stored thereon; a data access module provided by said computer system configured to identify the file type of said data file, wherein said computer system selects a program to compatibly access said data file based on said identified file type; and a data formatting module provided by said computer system to arrange the contact data within the accessed data file in accordance with a predetermined format.

It is a further aspect of the present invention to provide a method of automatically formatting contact data in at least one data file for use by a media generation system comprising providing a computer system configured to receive at least one data file of a predetermined file type, said computer system including at least one access module configured to automatically access data files of at least one type; identifying the file type of said at least one data file; selecting said at least one access module configured to access said at least one data file having the identified file type; invoking said at least one access module selected at said selecting step; accessing said data file; and formatting the contact data in accordance with a predetermined format.

### BRIEF DESCRIPTION OF THE DRAWINGS

These and other features and advantages of the present invention will become better understood with regard to the following description, appended claims, and accompanying drawings where:

FIG. 1 is a block diagram showing the components of an automated file-conversion system for a media-generation system in accordance with the concepts of the present invention; and

FIG. 2 is a flow diagram showing the operational steps taken by the automated file-conversion system for a media-generation system in accordance with the concepts of the present invention.

### DETAILED DESCRIPTION OF THE INVENTION

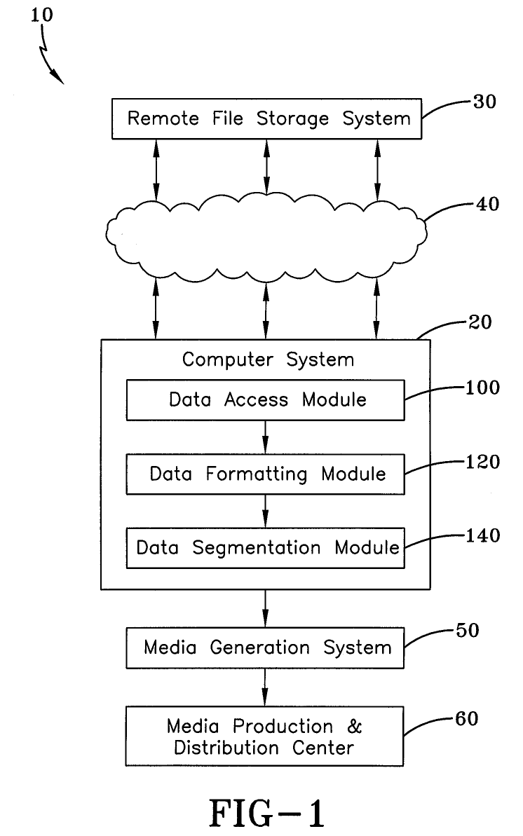

An automated file-conversion system is generally referred to by the numeral 10, as shown in FIG. 1 of the drawings. The system 10 includes a computer system 20 that communicates with a remote file storage system 30 via a communication network 40, such as the Internet for example. Various users of the system 10 upload data files that contain one or more contact data records to the remote file storage system 30, whereupon the computer system 20 acquires and processes the data files in a manner to be discussed. It should be appreciated that for the purposes of the following discussion, the term “data file” is defined herein as any computer-readable file or database. Specifically, contact data is stored within each of the contact data records and includes any data, such as the name, address, preferences, demographic data, or other personally-identifying information that is associated with various individuals to whom a user of the system 10 desires to send targeted communications, such as direct mailings, emails, persistent universal resource locators (URL) and microsites for example. Moreover, the contact data that is stored in the data file at the remote file storage system 30 is acquired from various data-acquisition sources, such as point-of-sale terminals, over-the-phone entries, on-line surveys, customer supplied databases and the like. However, the data acquired is stored in various files and databases that format or arrange the data in a variety of manners. As such, this raw contact data collected by the third-party systems is generally unformatted and unsuitable for processing by a media-generation system 50, such as an XMPIE-based media-generation system, that is coupled to the computer system 20, which utilizes the contact data to generate customized and targeted media communications for the intended recipient.

Specifically, the computer system 20 accesses the file storage system 30 via the computer network 40 and identifies the file type of the data file, such as whether it is an EXCEL spreadsheet file (XLS) or an extensible markup language file (XML), for example. Once the file type of the data file is identified, the computer system 20 opens or otherwise accesses the data file so that the raw unformatted data within each data record can be edited or delimited into a standardized format, such as a comma separated value (CSV) format that is compatible for use with the media-generation system 50. After the data within each data record is formatted, the computer system 20 segments the data records in accordance with predefined rules or criteria and then subsequently saves the segmented group of data files as a standardized production file that is compatible for use by the media-generation system 50 for the generation of targeted media communications, which are produced and delivered to the target by a media production and distribution center 60.

The computer system 20 provided by the system 10 comprises any suitable computer system that includes the necessary hardware and software to carry out the functions to be discussed. Coupled to the computer system 20 via the communication network 40 is the remote file storage system 30 that is configured to store various data files provided to it by users of the system 10. The remote file storage system 30 may comprise a data server or any other data storage unit. It should be appreciated that the contact data may be transferred to the remote file storage system 30 and retrieved from the remote file storage system 30 by the computer system 20 using any suitable data protocol, such as file transfer protocol (FTP) for example.

In addition, the computer system 20 is configured to include various operating modules that comprise software functions that are used to process the contact data contained within each of the data files that are stored at the system 10. Specifically, the computer system 20 includes a data access module 100, a data-formatting module 120, and a data segmentation module 140 that communicate with each other. The data access module 100 is configured to identify the type of data file that is acquired from the file storage system 30 by reading an identification code that is embedded in each of the data files. That is, the embedded identification code identifies the particular type of file that comprises the data file. Specifically, the data access module 100 searches the data file for an embedded hexadecimal code that identifies the particular type of file that comprises the data file. As such, based on the hexadecimal code identified, the access module 100 is able to determine if the data file comprises one of the following data types that includes, but is not limited to, a tab delimited text (TXT) file type; a comma separated value (CSV) file type; a delimited by colon, semicolon, or pipe (TXT) file type; a Microsoft EXCEL spreadsheet (XLS or XLSX) file type; portable document format (PDF); hypertext mark-up language (HTM, HTML, MHT, XHTML) file type; extensible mark-up language (XML) file type; database format (DBF) file type; and printer file (PRN) file type.

Once the data access module 100 identifies the file type of the data file, the computer system 20 selects the appropriate software editor that is compatible with the identified file type to open or otherwise access the data file. Once the data file has been opened, the data-formatting module 120 accesses the raw, unformatted contact data contained therein and formats it so that it is placed in a predetermined standardized format. For example, the data-formatting module 120 may comprise a data edition that automatically processes the raw, unformatted contact data by delimiting the various data contained in the data file so that it is placed in a comma separated value (CSV) format or arrangement that is compatible for use with the media-generation system 50 that generates the media content. After the raw contact data is placed in a standardized format, the data segmentation module 140 executes a set of segmentation or business rules that define the criteria in which specific contact data records within the data file are selected for use by the media-generation system 50. For example, the data segmentation module 140 may be configured to segment data using any Boolean expression or logic, such as nested Boolean logic, based on each data type associated with the various data fields that define a given record in the data file. For example, the contact data in the data file may be organized, such that each data record has one or more data fields that include, but is not limited to: name, address, gender, age, organizational affiliations, and recent purchases. Thus, the logic implemented by the data segmentation module 140 is configured to select only those data records in which the values in their data fields meet specific rules or logic defined the by data segmentation module 140. As such, the system 10 is able to generate media communications that are targeted to only those individuals that meet specific criteria, defined by the segmentation logic, which is highly desirable.

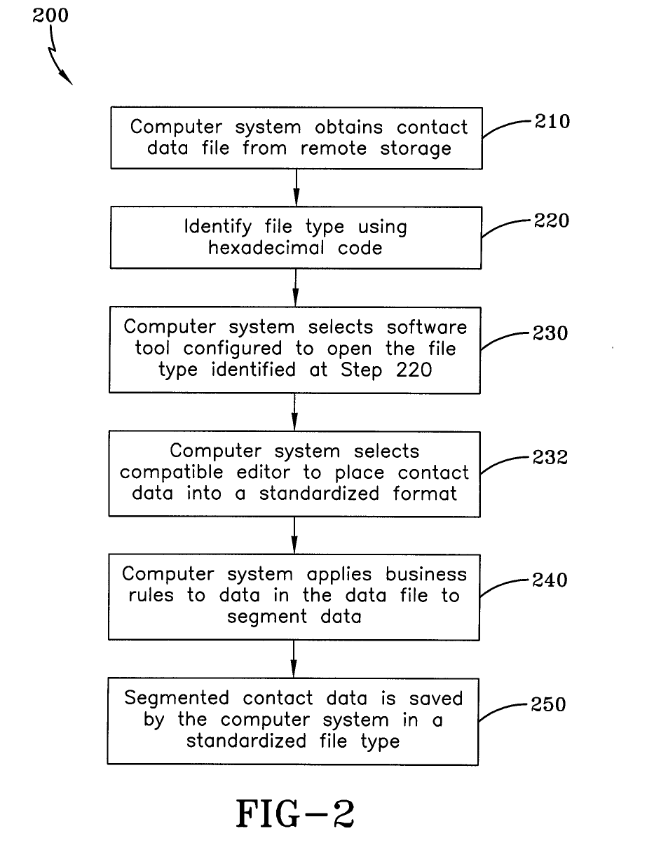

With the components of the system 10 set forth, the operational steps taken by the computer system 20 to convert the raw contact data files are generally referred to by the numeral 200, as shown in FIG. 2 of the drawings. Initially at step 210, the computer system 20 acquires the contact data file from the remote file storage system 30. Next at step 220, the data access module 100 of the computer system 20 identifies the type of file that comprises the contact data file. In particular, the data access module 100 analyzes the hexadecimal identification code that is embedded within each given data file to determine its file type. For example, the data access module 100 executed by the computer system 20 is configured to identify whether a data file is one of the following file types including, but not limited to: a text (TXT) file; a comma separated value (CSV) file; a delimited by colon, semicolon, or pipe file; a Microsoft EXCEL (XLS) file; a portable document format (PDF) file; a hypertext mark-up language (HTML) file; an XML (extensible mark-up language) file; a database format (DBF) file; or a printer (PRN) file. Moreover, the computer system 20 can be configured to identify the file type of any other file type by identifying the unique code, such as a hexadecimal code, that is embedded or otherwise associated with the particular data file being processed. Once the particular file type associated with the data file has been identified, the process 100 continues to step 230, where the computer system 20 invokes the data-formatting module 120 that provides a compatible software data editor that is configured to open or otherwise access data files of the particular file type identified at step 220. At step 232, the data-formatting module 120, which comprises a data editing program, edits the data of each of the data records so that it is arranged or otherwise formatted into a standardized form, such as a comma separated value (CSV) format. After the contact data file has been opened and formatted, the process continues to step 240, where the computer system 20 invokes the data segmentation module 140 that applies a set of predetermined, customized business rules, which define the manner in which the contact data records in the data file are to be segmented. After step 240 has been completed, the process continues to step 250 where the segmented contact data file is saved as a production data file by the computer system 20 as a standardized file type, such as a CSV (comma separated value) file that is compatible with the media-generation system 50, such as XMPIE for example. Once the segmented production file is processed by the media-generation system 50, a media communication is generated based on the segmented data and is sent to the media production and distribution center 60, where the completed media communication is produced for delivery to the target recipient.

It will, therefore, be appreciated that one advantage of one or more embodiments of the present invention is that an automated file-conversion system enables contact data files of any format to be opened and saved in a standardized format that is compatible with a media-generation system, such as XMPIE. Another advantage of the present invention is that an automated file-conversion system enables contact data files of any format to be opened, segmented, and then saved in a compatible file format for subsequent processing by a media-generation system, such as XMPIE.

Although the present invention has been described in considerable detail with reference to certain embodiments, other embodiments are possible. Therefore, the spirit and scope of the appended claims should not be limited to the description of the embodiments contained herein.

What is claimed is:

1. An automated file-conversion system comprising:
a computer system adapted to receive at least one data file having a file type, the at least one data file having contact data stored thereon;
a data access module provided by said computer system configured to identify the file type of said data file, wherein said computer system selects a program to compatibly access said data file based on said identified file type; and
a data formatting module provided by said computer system to arrange the contact data within the accessed data file in accordance with a predetermined format.

2. The automated file-conversion system of claim 1, wherein said computer system identifies the file type of the data files from an embedded code provided by the at least one data file.

3. The automated file-conversion system of claim 1, further comprising a data segmentation module coupled to said data formatting module, wherein said data segmentation module selects a portion of said data based on at least one segmentation rule.

4. The automated file-conversion system of claim 3, wherein said at least one data segmentation rule is defined by Boolean logic.

5. The automated file-conversion system of claim 3, further comprising a media generation system coupled to said data segmentation module, said media generation system generating a communication using said segmented contact data.

6. A method of automatically formatting contact data in at least one data file for use by a media generation system comprising:
providing a computer system configured to receive at least one data file of a predetermined file type, said computer system including at least one access module configured to automatically access data files of at least one type;
identifying the file type of said at least one data file;
selecting said at least one access module configured to access said at least one data file having the identified file type;
invoking said at least one access module selected at said selecting step;
accessing said data file; and
formatting the contact data in accordance with a predetermined format.

7. The method of claim 6, further comprising:
segmenting said data in accordance with predetermined criteria.

8. The method of claim 6, wherein said identifying step is completed by identifying a hexadecimal code associated with said at least one data file.

9. The method of claim 6, wherein said identifying step is
